(19) United States
(12) Patent Application Publication
(10) Pub. No.: US 2018/0131247 A1
(43) Pub. Date: May 10, 2018

(54) UNENCLOSED ELECTRICAL MACHINE

(71) Applicant: Continental Automotive GmbH, Hannover (DE)

(72) Inventors: Holger Froehlich, Berlin (DE); Soenke Guertler, Berlin (DE)

(21) Appl. No.: 15/569,719

(22) PCT Filed: Apr. 6, 2016
(86) PCT No.: PCT/EP2016/057496

§ 371 Date: Oct. 26, 2017

(30) Foreign Application Priority Data
Apr. 29, 2015 (DE) 10 2015 207 865.5

(51) Int. Cl. H02K 5/10; H02K 1/20; H02K 5/15; H02K 9/19

(52) U.S. Cl. CPC H02K 5/10; H02K 9/19; H02K 5/15; H02K 1/20

(57) ABSTRACT

The invention discloses an unenclosed electrical machine (EM), comprising: —a stator (ST), within which there is a cavity (HR); —an insulating sheath (IU), which seals off an outer circumferential surface (UF) and at least one side face (SF1) of the stator (ST) in a media-tight manner; —at least one end shield (LS1, LS2), which is arranged on the side face (SF1) of the stator (ST) and delimits the cavity (HR) on one side; —at least one sealing arrangement (DA), which is arranged between the insulating sheath (IU) and the at least one end shield (LS1, LS2), and seals off the cavity (HR) from the surroundings in a media-tight manner.

### TECHNICAL FIELD

The invention relates to an electrical machine that is used, in particular, as a drive unit of a hybrid-electric/electric vehicle.

### PRIOR ART

Electrical machines, in particular for an application as a drive unit of a hybrid-electric/electric vehicle, in particular the stators thereof, generate waste heat during operation because of the power dissipation. This waste heat can result in a power failure in the electrical machines, and must therefore be removed promptly after it is produced. For this purpose, the electrical machines are accommodated in enclosures, which are provided with cooling channels. When the electrical machines are in operation, a cooling fluid such as, for example, cooling water, flows through the cooling channels and removes the waste heat produced in the electrical machines.

As in the case of all technical devices, in particular in the case of components of hybrid-electric/electric vehicles, there is the general requirement for the electrical machines to be constructed such that they are more compact, more saving of weight and, moreover, less expensive.

The object of the present invention therefore consists in indicating a possibility by which an electrical machine can be produced such that it is more compact, lighter and, moreover, less expensive.

### DESCRIPTION OF THE INVENTION

This object is achieved by independent claim 1. Advantageous designs constitute subject matter of the dependent claims.

According to the invention, an unenclosed electrical machine is provided. The electrical machine comprises a stator, which is realized (substantially in the form of a hollow cylinder) so as to surround a (substantially cylindrical) cavity, wherein the cavity is preferably designed to receive a rotor of the electrical machine. The stator has an insulating sheath, which surrounds an outer circumferential surface and a least one side face of the stator in the manner of a membrane, and seals off the stator from the surroundings in a media-tight manner. The electrical machine further comprises an end shield, which is arranged on the side face of the stator and delimits the cavity on one side. The electrical machine additionally comprises at least one sealing arrangement, which is arranged between the insulating sheath and the end shield, and realizes a seal that seals off the cavity from the surroundings in a media-tight manner. The seal in this case is preferably realized so as to be form-fitting or force-fitting.

The electrical machine thus comprises, instead of an enclosure, an insulating sheath that spatially insulates the stator from the surroundings. The insulating sheath in this case is realized in the form of a media-tight, but thermally conductive, membrane-type layer, which covers the outer circumferential surface and at least one side face, or the two side faces, of the stator, and thereby insulates the stator from the surroundings in a media-tight manner. This insulating sheath in this case is sufficiently thick to insulate the stator in a media-tight manner and, at the same time, is sufficiently thin to be able to efficiently dissipate from the stator the waste heat that is produced in the stator when the electrical machine is in operation.

In comparison with a conventional enclosure, the insulating sheath is substantially more saving of structural space and weight, and at the same time can be produced less expensively.

In particular, the insulating sheath forms a thin, uniform, membrane-like layer that adheres to or on the stator, and that is thus physically connected to the stator. The insulating sheath thus provides for uniform insulation and, at the same time, homogeneous cooling of the stator.

The insulating sheath in this case may be produced by an injection molding process. The injection molding process allows the production of large-area, thin insulating coatings. The injection molding process enables the insulating sheath, having improved insulating and cooling properties, to be applied inexpensively to the stator.

Alternatively, the insulating sheath may be produced in a (another) coating process such as, for example, painting (spray painting, immersion coating) or fluidized bed coating.

Since the stator is now thermally connected to the surroundings only via the thin insulating sheath as a heat sink, the waste heat that is produced in the stator can be removed more rapidly, and therefore more efficiently, via the (thin) insulating sheath.

The, in particular form-fitting or force-fitting, sealing arrangement between the stator and the end shield renders possible, without additional pretensioning, a media-tight seal for the cavity in which, for example, the rotor of the electrical machine is arranged.

The insulating sheath can also replace elaborate slot lining of the stator, and thus enables further saving to be realized in the electrical machine.

There is thus provided an unenclosed electrical machine that can be produced inexpensively, occupies little structural space and, at the same time, is lighter than conventional electrical machines (having conventional enclosures) of the same output class.

Preferably, the sealing arrangement comprises at least one first projection, which is realized so as to extend (for example, in the form of a circular ring) on the end shield in the circumferential direction of the cavity. The first projection projects into the insulating sheath (one the side face of the stator) and thus forms, with the insulating sheath, the form-fitting, media-tight seal for the cavity.

As an alternative or in addition to the first projection, the sealing arrangement preferably also has a recess, which is realized so as to extend (for example, in the form a circular ring) on the end shield in the circumferential direction of the cavity. The insulating sheath, or a projection on the insulating sheath that is realized in the form of a ring, projects in this recess and thus forms, with the recess, the form-fitting, media-tight seal for the cavity.

The first projection preferably has a cutting-ring type contour, which digs into the insulating sheath and thereby produces the form-fitting, media-tight connection between the stator and the end shield. The first projection may be formed on the end shield in a process of forming the end shield. The form-fit is produced by screw-connecting, or tensioning the end shield, together with the first projection, to the stator provided with the insulating sheath. The surface relaxation of the insulating sheath in this case is deliberately used to produce the form-fit. As the end shield is being screw-connected or tensioned to the stator, the cutting-ring type contour of the first projection penetrates the insulating sheath and results in surface relaxation in the insulating sheath, thereby producing the form-fit between the stator and the end shield.

As an alternative or in addition to the first projection, the sealing arrangement has a shaped seal, in particular an elastomer shaped seal, for example of polyacrylate rubber, which is arranged in a depression on the end shield that extends (for example, in the form of a circular ring) in the circumferential direction of the cavity. The inner wall of the depression in this case presses the shaped seal in the direction of the insulating sheath, such that the shaped seal, together with the insulating sheath, realizes the form-fitting, media-tight seal for the cavity.

The use of this shaped seal is preferably realized by the action of a force shunt. The shaped seal has a high sealing potential with a low force requirement. The shaped seal in this case has profile geometries that are specifically matched to the application, such as, for example, a substantially rectangular cross section having, on a plurality of sides, dome-shaped convexities, which guarantee an optimum seal.

The insulating sheath preferably includes a thermoplastic and thermally conductive plastic, which are obtainable at low cost in differing variants. In particular, the insulating sheath is composed largely, specifically entirely, of a thermally conductive plastic such as, for example, a thermoplastic or thermosetting material.

By means of the injection molding process, the stator is insulated in an inexpensive manner. Here, the laminated core of the stator (preferably preheated) is inserted in a mould and selectively coated with plastic. The injection molding replaces the bands, foils etc. that are otherwise used in conventional stator insulation. Consequently, the injection molding process can offer further cost savings and production advantages. A laminated core made of steel is used as an insert part. Injection molding also offers slot and end insulations, clamp mountings, contour supports, guide slots and cooling channels for the winding, and all in a single production step.

Preferably the stator has a first cooling channel, which serves to transport a cooling fluid for cooling the stator. The first cooling channel has a first opening, which is realized on the side face of the stator, and through which the cooling fluid can flow into and out of the first cooling channel. The previously described sealing arrangement seals off the first cooling channel, or the first opening, from the surroundings in a media-tight manner.

The cooling channels realized in the body of the stator provide for fluid cooling directly where the waste heat is produced. Such direct cooling is more efficient than cooling of the stator by means of cooling channels realized in an enclosure wall of an enclosure of the electrical machine, a prerequisite of which is an efficient transfer of heat from the stator to the enclosure wall.

Preferably, the stator has, on an inner wall of the first cooling channel, an insulating layer, which covers the inner wall of the cooling channel in the manner of a membrane and thereby seals off the cooling channel from the surroundings, or from the body (laminated core) of the stator, in a media-tight manner.

The insulating layer preferably likewise includes a thermoplastic and heat-conducting plastic such as, for example, a thermosetting plastic or a thermoplastic, which is applied to or on the inner wall of the first cooling channel by injection molding around the latter.

The insulating layer is preferably realized as a single piece with the insulating sheath. In particular, the insulating layer and the insulating sheath are realized in one and the same injection molding process, from one and the same casting compound, and thus from one and the same thermoplastic and thermally conductive plastic.

The injection molding process renders possible the production of the insulating sheath and the insulating layer, which can be realized so as to be of large area, thin and continuous (without cracks).

The insulating layer preferably has a number of projections projecting into the first cooling channel, which are shaped and arranged, spatially offset from each other, in the first cooling channel in such a manner that they generate turbulences in the cooling fluid flowing through the first cooling channel. These turbulences improve the absorption of heat by the cooling fluid, since a boundary layer cannot form. In addition, the projections increase the surface area of heat transfer from the stator to the first cooling channel, and thereby increase the efficiency of the heat transfer.

Preferably, the end shield has a second cooling channel for transporting the cooling fluid, which cooling channel, for its part, has a second opening, which is realized on a side face that faces toward the stator, and through which the cooling fluid can flow into and out of the second cooling channel. The first and the second opening in this case are realized in alignment with each other, and are sealed off from the surroundings, or from the cavity, in a media-tight manner by the previously described sealing arrangement.

### BRIEF DESCRIPTION OF THE DRAWINGS

Exemplary embodiments of the invention are explained in greater detail in the following with reference to the accompanying drawings. There are shown therein:

FIG. 1 an electrical machine according to an embodiment of the invention, in a schematic cross-sectional representation;

FIG. 2 a detail of the electrical machine represented in FIG. 1, in a schematic cross-sectional representation;

FIG. 3 a detail of an electrical machine according to a further embodiment of the invention, in a schematic cross-sectional representation;

FIG. 4A, 4B, 4C three embodiments of an elastomer shaped seal of the electrical machine represented in FIG. 3, each in schematic cross-sectional representations;

FIG. 5A, 5B in each case a stator of an electrical machine according to two exemplary embodiments of the invention, in respective perspective representations;

FIG. 6 a detail of the stator represented in FIG. 5A, in a schematic cross-sectional representation.

### DETAILED DESCRIPTION OF THE DRAWINGS

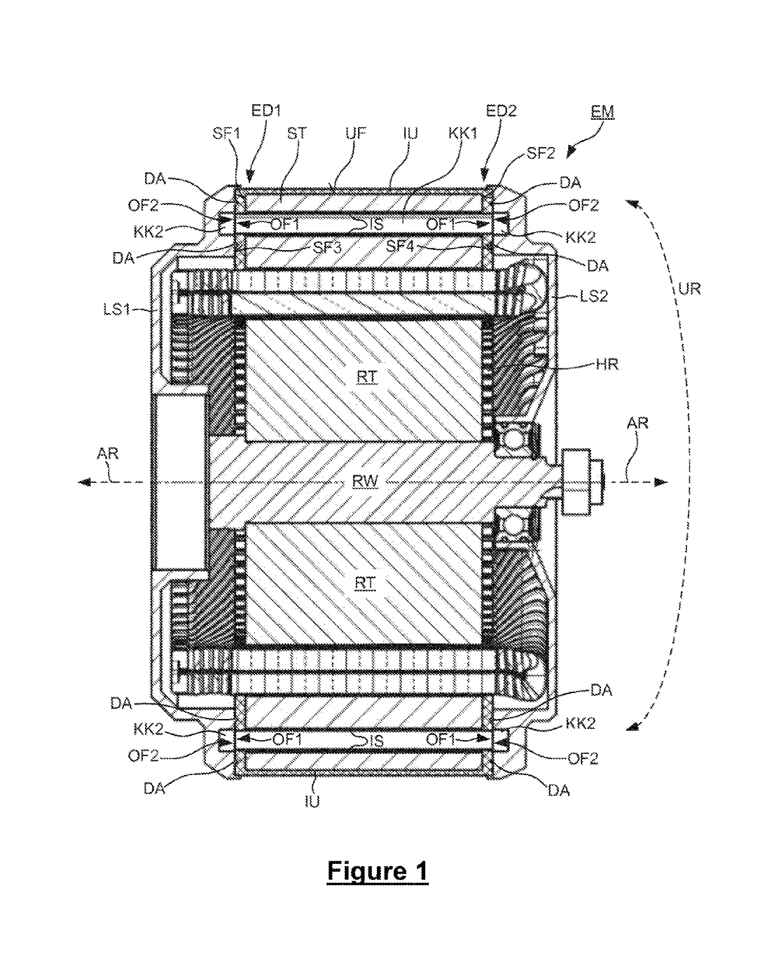

FIG. 1 shows an electrical machine EM in a schematic cross-sectional representation.

The electrical machine EM comprises a stator ST, which extends, in the form of a hollow cylinder, in an axial direction AR of the electrical machine EM and surrounds a cylindrical cavity HR. The electrical machine EM further comprises two end shields LS1, LS2, which are arranged at one of the two axial ends of the stator ST and respectively close off the cavity HR on one side. The electrical machine EM further comprises a rotor RT, together with a rotor shaft RW, which rotor is arranged in the cavity HR, concentrically in relation to the stator ST, and rotatably mounted on the two end shields LS1, LS2 by means of the rotor shaft RW.

The stator ST is preferably realized as a laminated core, composed of a multiplicity of thin, electrical sheets in an axial stack. In this case, provided in the respective sheet sections of the electrical sheets there are corresponding openings, which are realized by punching. When the electrical sheets are joined together to form the laminated core, the openings are brought into alignment with each other, such that, following the assembling of the stator ST, they form first cooling channels KK1, which each extend, in the axial direction AR of the stator ST, through from the one axial end ED1 to the other axial end ED2 of the stator ST. The first cooling channels KK1 are designed to transport a cooling fluid for cooling the stator ST when the electrical machine EM is in operation. At respective ends, the first cooling channels KK1 each have an opening OF1, through which the cooling fluid can flow into and out of the respective cooling channels KK1.

The stator ST further has an insulating sheath IU, which, in the manner of a membrane, covers an outer circumferential surface UF and both side faces SF1, SF2 of the stator ST and seals them off in a media-tight manner.

On the inner wall of the respective first cooling channels KK1, the stator ST in each case has an insulating layer IS, which, in the manner of a membrane, cover the inner wall of the respective cooling channels KK1 and seal off the respective cooling channels KK1 in a media-tight manner.

The insulating sheath IU and the insulating layers IS are realized as a single piece, from one and the same casting compound, which is injection-molded in an injection molding process on or at the stator. The casting compound is composed of a thermosetting or thermoplastic material, which is thermally conductive and electrically insulating.

The two end shields LS1, LS2 each have a number of second cooling channels KK2 and channel deflections (not represented in FIG. 1), wherein the channel deflections fluidically connect the corresponding second cooling channels KK2 to each other.

At respective ends that face toward the stator ST, the second cooling channels KK2 each have an opening OF2, through which the cooling fluid can flow into and out of the respective second cooling channels KK2.

The openings OF1 of the first cooling channels KK1 and the openings OF2 of the corresponding second cooling channels KK2 are in alignment with each other, such that the cooling fluid can flow in an unimpeded manner from the respective first cooling channels KK1 to the corresponding second cooling channels KK2, and vice versa. The first and the second cooling channels KK1, KK2 thus together form a cooling circuit for cooling the electrical machine EM.

The electrical machine EM additionally has four sealing arrangements DA.

The four sealing arrangements DA are each realized in the form of a circular ring, as viewed in the axial direction AR, and are realized concentrically in relation to each other and to the cavity HR. In this case, two of the sealing arrangements DA are arranged between the left side face SF1 of the stator ST and a corresponding side face SF3 of the left end shield LS1, and two further sealing arrangements DA are arranged between the right side face SF2 of the stator ST and a corresponding side face SF4 of the right end shield LS2.

As viewed in the radial direction from the rotor shaft RW, respectively one of the two left-side and one of the two right-side sealing arrangements DA are arranged between the cavity HR and the first cooling channels KK1. These sealing arrangements DA seal off the cavity HR from the cooling channels KK1, KK2 and from the surroundings in a media-tight manner.

As viewed in the radial direction from the rotor shaft RW, the respectively other of the two left-side and of the two right-side sealing arrangements DA are arranged between the first cooling channels KK1 and the circumferential surface UF of the stator ST. These two sealing arrangements DA seal off the cooling channels KK1, KK2 from the surroundings in a media-tight manner.

The two end shields LS1, LS2 are tensioned, for example by means of tension rods (not represented in FIG. 1), with the stator ST. The two ends of the respective tension rods in this case are thicker than the corresponding shafts, in order to ensure improved safety and fatigue strength.

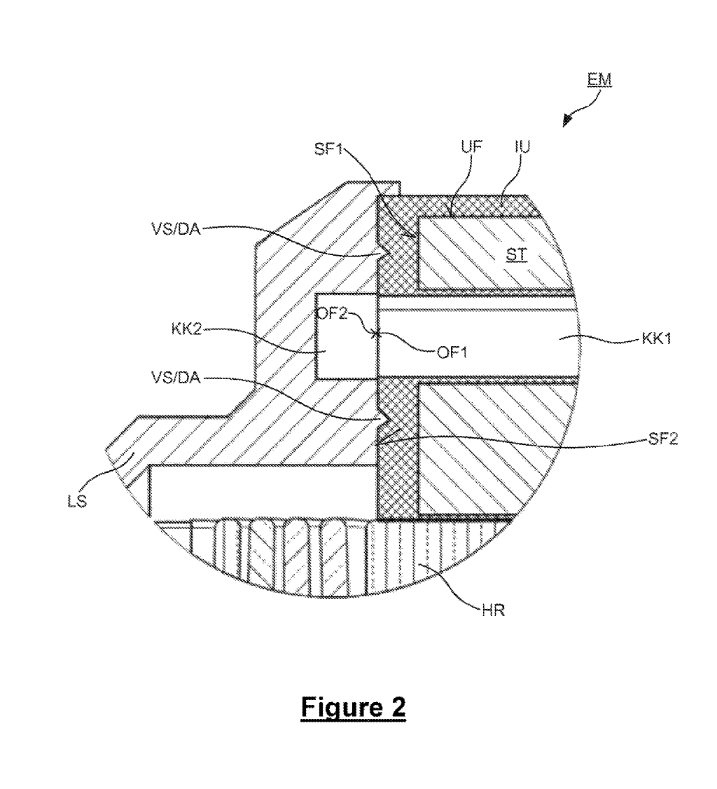

FIG. 2 shows a detail of the electrical machine EM represented in FIG. 1, in which two of the sealing arrangements DA described above are represented in detail. In this embodiment, the sealing arrangements DA each comprise a projection VS, formed on the side faces SF2, SF4 of the respective end shields LS1, LS2 and surrounding the cavity HR, in the form of a circular ring, in the circumferential direction UR. These projections VS, as viewed in their respective circumferential direction UR, have a triangular cross section, tapering from the side faces SF2, SF4 of the respective end shields LS1, LS2 toward the stator ST. The projections VS are realized in the manner of a cutting ring at both of the side faces projecting from the side faces SF2, SF4 of the respective end shields LS1, LS2.

Upon assembly of the electrical machine EM, the respective end shields LS1, LS2 are attached laterally to the stator ST, in the axial direction AR, and fastened. The projections VS realized in the manner of cutting rings then cut into the insulating sheath IU of the side faces SF1, SF2 of the stator ST, as a result of which the respective projections VS dig into the insulating sheath IU and, together with the insulating sheath IU, realize a form-fitting, media-tight seal for the cooling channels KK1, KK2, or for the cavity HR.

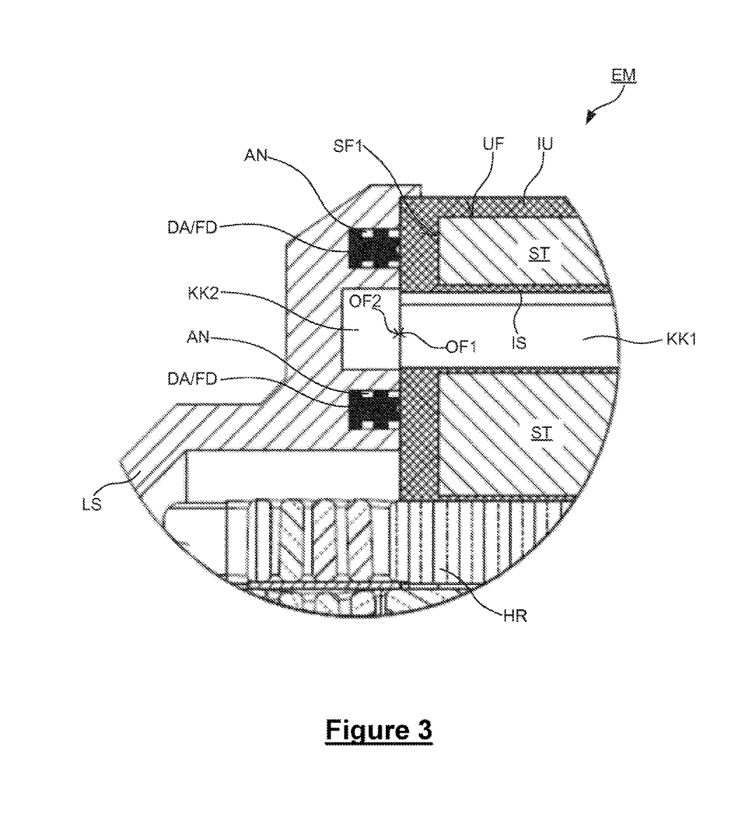

FIG. 3 shows a detail of an electrical machine EM according to a further embodiment of the invention. In this embodiment, the sealing arrangements DA each comprise an elastomer shaped seal FD, which has the shape of an O-ring having an irregular cross section.

The elastomer shaped seals FD are arranged, respectively, in a recess AN provided therefor, which are formed, in the form of a ring, on the respective end shield LS1, LS2. Upon assembly of the electrical machine EM, the elastomer shaped seals FD are pressed by the respective end shields LS1, LS2, or the inner walls of the recesses AN on the respective end shields LS1, LS2, toward the insulating sheath IU (in the region of the respective side faces SF1, SF2 of the stator ST) and thereby, together with the insulating sheath IU, seal off the cooling channels KK1, KK2 and the cavity HR from each other and from the surroundings. A seal is thereby produced in the force shunt, which seal has a high sealing potential with a low force requirement.

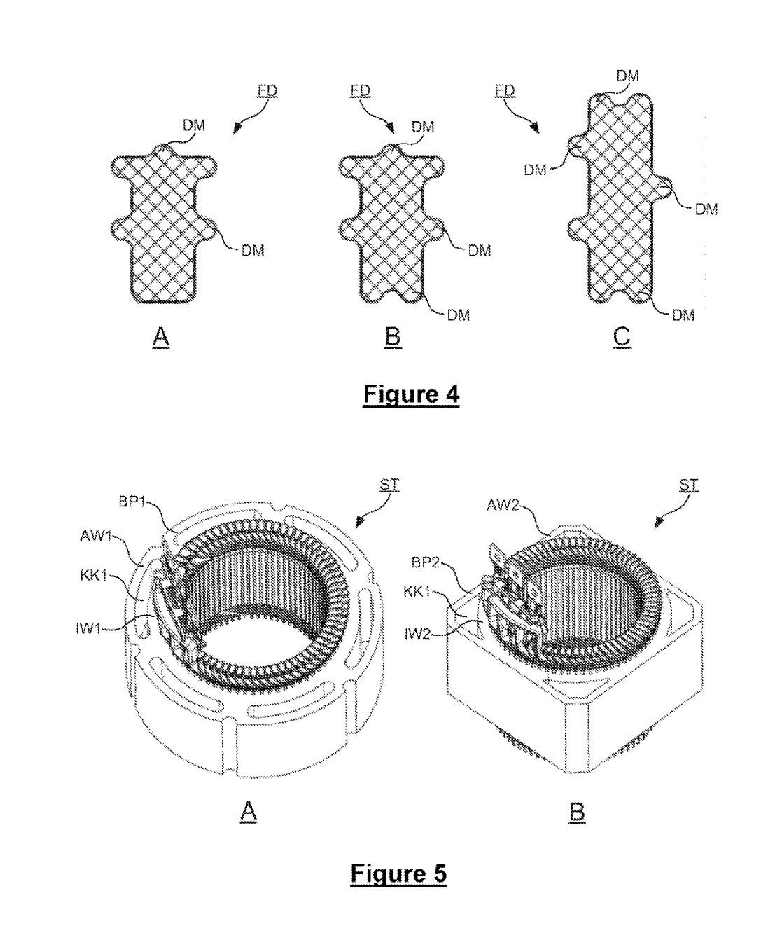

Cross sections of three exemplary embodiments of the elastomer shaped seal FD are depicted in FIGS. 4A, 4B and 4C.

The cross section of a first elastomer shaped seal in FIG. 4A has a substantially rectangular cross-sectional shape, which, on three sides, has five dome-shaped convexities DM, which extend in the form of a ring along the direction of extent of the respective elastomer shaped seals FD.

The cross section of a further elastomer shaped seal FD in FIG. 4B likewise has a substantially rectangular cross-sectional shape, which, however, on four sides, has dome-shaped convexities DM of differing heights, which extend in the form of a ring along the direction of extent of the respective elastomer shaped seals FD.

The cross section of yet another elastomer shaped seal FD in FIG. 4C has an elongate, rectangular cross-sectional shape, which, likewise on four sides, has dome-shaped convexities DM, which extend in the form of a ring along the direction of extent of the respective elastomer shaped seals FD.

Two embodiments of the stator ST of the electrical machine EM described in FIG. 1 are depicted, in respective perspective representations, in FIGS. 5A and 5B.

The stator ST represented in FIG. 5A has a laminated core BP1 having a round outer circumference. The laminated core BP1 comprises an outer wall AW1 and an inner wall IW1, wherein the two walls AW1, IW1 are realized in the form of a cylinder surface and are coaxial with each other. Between the two walls AW1, IW1, the stator ST has cooling channels KK1, which are realized in the form of hollow cylinder sectors and extend in the axial direction AR of the stator ST.

The stator ST represented in FIG. 5B has a laminated core BP2 having a substantially rectangular outer circumference. The laminated core BP2 has an outer wall AW2, which borders a cuboid cavity, and an inner wall IW2 in the form of a hollow cylinder, the cross section of which, as viewed in the axial direction AR of the stator ST, realizes an inscribed circle of the square cross section of the outer wall AW2. Between the two walls AW2, IW2, the stator ST has four cooling channels KK1, which extend in the axial direction AR of the stator ST, and the axial cross sections of which have substantially a triangular or trapezoidal shape.

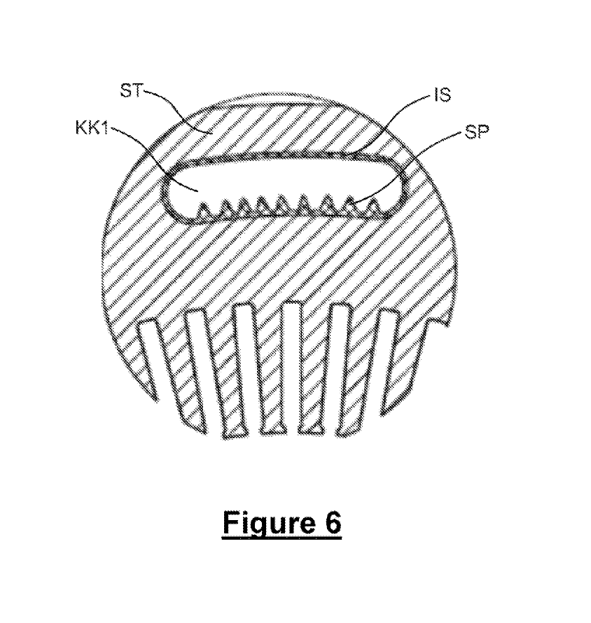

FIG. 6 shows a transverse detail of the stator represented in FIG. 5a, wherein a cooling channel KK1 of the stator ST is represented in the axial cross section thereof.

On the inner wall of the cooling channel KK1, the stator ST has the previously described insulating layer IS, which completely covers the inner wall of the cooling channel KK1 and thus seals off the cooling channel KK1 from the stator ST, or from the solid body of the laminated core BP1 of the stator ST, and from the surroundings, in a media-tight manner.

The insulating layer IS has a rough surface structure, having tooth-shaped projections SP realized so as to project into the first cooling channel KK1. These projections SP generate turbulences in the cooling fluid flowing through the first cooling channel KK1, as a result of which the cooling fluid can better absorb the waste heat from the stator ST.

The production of the stator ST described above preferably comprises the following method steps:

Firstly, a multiplicity of electrical sheets are punched from a thin metal sheet. Circular openings, which are arranged in a distributed manner over the circumference of the respective electrical sheets, are punched in sheet sections of the electrical sheets. In addition, slot cutouts, which are likewise arranged in a distributed manner over the circumference of the respective electrical sheets, are punched at inner edges of the respective electrical sheets.

The electrical sheets are then stacked on one other and assembled to form a laminated core BP1, BP2. Upon being stacked on one another, the electrical sheets are aligned to one another, such that the corresponding openings are in alignment with each other and thus realize the previously mentioned cooling channels KK1, which extend through axially over the entire length of the laminated core BP1, BP2. The slot cutouts form slots for receiving windings.

The provided injection molding technique for insulating the laminated core BP1, BP2 saves lamination, such as, for example, by welding, of the laminated core BP1, BP2.

The laminated core BP1, BP2 is covered with a casting compound, composed of a thermosetting or thermoplastic material, in an injection molding process. After hardening, the casting compound realizes the previously described insulating sheath IU for the laminated core BP1, BP2, or the stator ST, and the previously described insulating layer IS for the first cooling channels KK1. After hardening, the casting compound that covers the slots realizes the slot insulation, such that there is no need for slot insulating paper.

Then, in a manner known to persons skilled in the art, conductor rods are inserted in the slots and crossed in accordance with the winding pitch, and welded together to form windings.

The two end shields LS1, LS2, provided with the previously described sealing arrangements DA, are then attached laterally to the stator ST and fixedly connected to the stator ST. The sealing arrangement DA in this case, with the insulating sheath IU, realizes the form-fitting, media-tight seal for the cooling channels KK1, or for the stator ST, in the manner previously described.

1. An apparatus comprising:
a stator at least partially defining a cavity;
an insulating sheath sealing off an outer circumferential surface and at least one side face of the stator in a media-tight manner;
at least one end shield arranged on the side face of the stator and delimiting the cavity on one side;
at least one sealing arrangement arranged between the insulating sheath and the at least one end shield, and sealing off the cavity from surroundings in a media-tight manner.

2. The apparatus as claimed in claim 1, wherein the sealing arrangement comprises a first projection extending on the at least one end shield in circumferential direction of the cavity, and projecting into the insulating sheath, thus sealing off the cavity from the surroundings in a media-tight manner.

3. The apparatus as claimed in claim 1, wherein the sealing arrangement comprises a shaped seal in a depression on the at least one end shield that extends in the circumferential direction of the cavity and that, together with the insulating sheath, seals off the cavity from the surroundings in a media-tight manner.

4. The apparatus as claimed in claim 1, wherein the insulating sheath is comprises a thermally conductive plastic.

5. The apparatus as claimed in claim 1, wherein the stator defines a first cooling channel for transporting a cooling fluid, with a first opening for supplying and/or removing the cooling fluid, wherein the sealing arrangement seals off the first cooling channel, or the first opening, from the surroundings in a media-tight manner.

6. The apparatus as claimed in claim 5, wherein the stator comprises, on an inner wall of the first cooling channel, an insulating layer, wherein the insulating layer seals off the first cooling channel from the surroundings in a media-tight manner.

7. The apparatus as claimed in claim 6, wherein the insulating layer and the insulating sheath are produced in a single injection molding process.

8. The apparatus as claimed in claim 6, wherein the insulating layer and the insulating sheath are a single piece.

9. The apparatus as claimed in claim 6, wherein the insulating layer comprises a number of projections projecting into the first cooling channel, configured to generate turbulences in the cooling fluid flowing through the cooling channel.

10. The apparatus as claimed in claim 5, wherein the at least one end shield defines a second cooling channel configured to transport the cooling fluid, and a second opening for supplying and/or removing the cooling fluid, wherein the first opening and the second opening are in alignment with each other, and are sealed off from the surroundings in a media-tight manner by the sealing arrangement.

11. The apparatus as claimed in claim 3, wherein the shaped seal is an elastomer seal.

12. The apparatus as claimed in claim 4, wherein the insulating sheath is a thermally conductive plastic.

13. The apparatus as claimed in claim 12, wherein the thermally conductive plastic is selected from a group of a thermoplastic and a thermosetting material.
